(19) United States
(12) Patent Application Publication
(10) Pub. No.: US 2023/0119032 A1
(43) Pub. Date: Apr. 20, 2023

(54) DISPLAY SYSTEM AND DISPLAY METHOD

(71) Applicant: Nippon Telegraph and Telephone Corporation, Tokyo (JP)

(72) Inventors: Haruka KUBOTA, Musashino-shi, Tokyo (JP); Akira Kataoka, Musashino-shi, Tokyo (JP)

(21) Appl. No.: 17/793,522

(22) PCT Filed: Jan. 24, 2020
(86) PCT No.: PCT/JP2020/002628

§ 371 Date: Jul. 18, 2022

(51) Int. Cl. H04N 23/63

(52) U.S. Cl. CPC H04N 23/632; H04N 23/635

(57) ABSTRACT

In a display system (100), a map of a shot region is generated based on video information, and information on a shooting target on the map is stored in a parameter storage unit (13) in association with each scene in the video information. Then, when receiving specification of a position or range on the map through a user's operation, a display apparatus (10) searches for information on a scene in the video information in which the specified position or range is shot using the information on the shooting target in each scene stored in the parameter storage unit (13), and outputs found information on the scene.

### TECHNICAL FIELD

The present invention relates to a display system and a display method.

### BACKGROUND ART

Conventionally, it has been known that video information can accurately reproduce the situation at the time of shooting, and can be utilized in other fields regardless of personal or business use. For example, in performing work such as construction work, moving picture video such as camera video from the worker's point of view can be utilized as work logs for preparing manuals, operation analysis, work trails, and the like.

In such utilization, there are many cases where it is desired to extract only a specific scene from continuous video, but visual work is troublesome and inefficient. Therefore, there has been known a technique for detecting a specific scene by tagging each video scene.

For example, there have been known a method of performing tagging from information in video by performing image recognition based on face authentication or object authentication or voice recognition for detecting specific words or sounds, and an approach of giving semantic information to each scene based on sensor values acquired synchronously with shooting or the like.

Further, as a technique for extracting only a specific scene, there is a technique of identifying persons or objects based on their features and automatically searching video for a specific scene based on the transition of relationship between the persons or objects abstracted by proxemics or the like (see Non-Patent Literature 1).

### CITATION LIST

### Non-Patent Literature

Non-Patent Literature 1: Sheng Hu, Jianquan Liu, Shoji Nishimura, “High-Speed Analysis and Search of Dynamic Scenes in Massive Videos”, Technical Report of Information Processing Society of Japan, 2017 Nov. 8

### SUMMARY OF THE INVENTION

### Technical Problem

The conventional method has a problem that there are cases where a specific scene cannot be efficiently extracted from video when there are many similar objects. For example, since there are many similar objects, prior preparation is needed when using tags or sensors to identify each object individually. Further, for example, in the above-mentioned technique of identifying persons or objects based on their features and automatically searching video for a specific scene based on the transition of relationship between the persons or objects abstracted by proxemics or the like, it is difficult to distinguish a specific scene in a region where there are many similar objects.

### Means for Solving the Problem

In order to solve the above-described problems and achieve the object, a display system of the present invention includes: a video processing unit that generates a map of a shot region based on video information, and acquires information on a shooting target on the map in association with each scene in the video information; and a search processing unit that, when receiving specification of a position or range on the map through a user's operation, searches for information on a scene in the video information in which the specified position or range is shot using the information on the shooting target in each scene, and outputs found information on the scene.

### Effects of the Invention

According to the present invention, an effect is produced that a specific scene can be efficiently extracted from video even when there are many similar objects.

### BRIEF DESCRIPTION OF DRAWINGS

FIG. 1 is a diagram showing an example of a configuration of a display system according to a first embodiment.

FIG. 2 is a diagram illustrating setting of search options.

FIG. 3 is a diagram showing an example of display of a found video scene.

FIG. 4 is a flowchart showing an example of a processing flow at the time of storing video and parameters in a display apparatus according to the first embodiment.

FIG. 5 is a flowchart showing an example of a processing flow at the time of searching in the display apparatus according to the first embodiment.

FIG. 6 is a diagram showing an example of a configuration of a display system according to a second embodiment.

FIG. 7 is a flowchart showing an example of a processing flow at the time of storing video and parameters in a display apparatus according to the second embodiment.

FIG. 8 is a flowchart showing an example of a processing flow at the time of searching in the display apparatus according to the second embodiment.

FIG. 9 is a diagram showing an example of a configuration of a display system according to a third embodiment.

FIG. 10 is a diagram illustrating an outline of a process of searching for a scene from the real-time viewpoint.

FIG. 11 is a flowchart showing an example of a processing flow at the time of searching in the display apparatus according to the third embodiment.

FIG. 12 is a diagram showing an example of a configuration of a display system according to a fourth embodiment.

### DESCRIPTION OF EMBODIMENTS

Hereinafter, embodiments of display systems and display methods according to the present application will be described in detail based on the drawings. Note that the display systems and the display methods according to the present application are not limited by these embodiments.

### First Embodiment

In the following embodiment, a configuration of a display system 100 and a processing flow of a display apparatus 10 according to a first embodiment will be described in order, and effects of the first embodiment will be described finally.

### Configuration of Display System

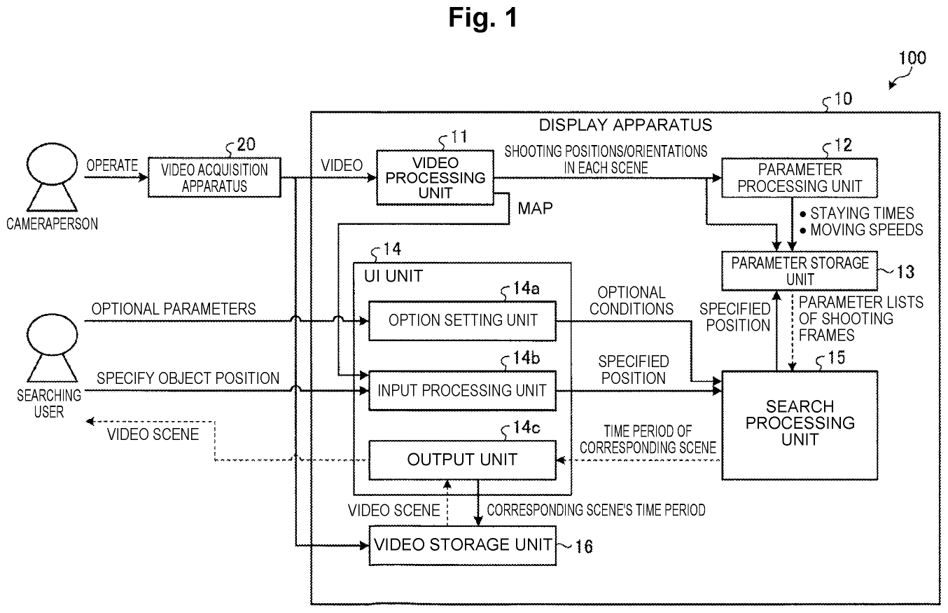

First, a configuration of the display system 100 will be described using FIG. 1. FIG. 1 is a diagram showing an example of a configuration of a display system according to the first embodiment. The display system 100 has the display apparatus 10 and a video acquisition apparatus 20.

The display apparatus 10 is an apparatus that allows an object position or range to be specified on a map including a shooting range shot by the video acquisition apparatus 20, searches video for a video scene including the specified position as a subject, and outputs it. Note that although the example of FIG. 1 is shown assuming that the display apparatus 10 functions as a terminal apparatus, there is no limitation to this, and it may function as a server, or may output a found video scene to a user terminal.

The video acquisition apparatus 20 is equipment such as a camera that shoots video. Note that although the example of FIG. 1 illustrates a case where the display apparatus 10 and the video acquisition apparatus 20 are separate apparatuses, the display apparatus 10 may have the functions of the video acquisition apparatus 20. The video acquisition apparatus 20 notifies a video processing unit 11 of data of video shot by a cameraperson, and stores it in a video storage unit 16.

The display apparatus 10 has the video processing unit 11, a parameter processing unit 12, a parameter storage unit 13, a UI (user interface) unit 14, a search processing unit 15, and the video storage unit 16. Each unit will be described below. Note that each of the above-mentioned units may be held by a plurality of apparatuses in a distributed manner. For example, the display apparatus 10 may have the video processing unit 11, the parameter processing unit 12, the parameter storage unit 13, the UI unit 14, and the search processing unit 15, and another apparatus may have the video storage unit 16.

Note that the parameter storage unit 13 and the video storage unit 16 are implemented by, for example, a semiconductor memory element such as a RAM (random access memory) or a flash memory, or a storage device such as a hard disk or an optical disc. Further, the video processing unit 11, the parameter processing unit 12, the parameter storage unit 13, the UI unit 14, and the search processing unit 15 are an electronic circuit such as a CPU (central processing unit) or an MPU (micro processing unit).

The video processing unit 11 generates a map of a shot region based on video information, and acquires information on a shooting target on the map in association with each scene in the video information.

For example, the video processing unit 11 generates a map from the video information using the technique of SLAM (simultaneous localization and mapping), and notifies an input processing unit 14b of information on the map. Further, the video processing unit 11 acquires a shooting position and a shooting direction on the map as the information on the shooting target in association with each scene in the video information, notifies the parameter processing unit 12 of them, and stores them in the parameter storage unit 13. Note that there is no limitation to the technique of SLAM, and other techniques may be substituted.

Although SLAM is a technique for simultaneously performing self-position estimation and environment map creation, it is assumed in this embodiment that the technique of Visual SLAM is used. In Visual SLAM, pixels or feature points between consecutive frames in video are tracked to estimate the displacement of the self-position using the displacement between the frames. Furthermore, the positions of the pixels or feature points used at that time are mapped as a three-dimensional point cloud to reconstruct an environment map of the shooting environment.

Further, in Visual SLAM, when the self-position has looped, reconstruction of the entire point cloud map (loop closing) is performed so that a previously generated point cloud and a newly mapped point cloud do not conflict with each other. Note that in Visual SLAM, the accuracy, map characteristics, available algorithms, and the like differ depending on the used device, such as a monocular camera, a stereo camera, and an RGB-D camera.

By applying the technique of SLAM and using video and camera parameters (e.g., depth values from an RGB-D camera) as input data, the video processing unit 11 can obtain a point cloud map and pose information of each key frame (a frame time (time stamp), a shooting position (an x coordinate, a y coordinate, and a z coordinate), and a shooting direction (a direction vector or quaternion)) as output data.

The parameter processing unit 12 calculates staying times and moving speeds from the shooting positions and orientations in each scene, and stores them in the parameter storage unit 13. Specifically, the parameter processing unit 12 receives the frame times (time stamps), the shooting positions, and the shooting directions in each scene in the video information from the video processing unit 11, calculates staying times and moving speeds based on the frame times (time stamps), the shooting positions, and the shooting directions, and stores them in the parameter storage unit 13.

The parameter storage unit 13 saves the frame times (time stamps), the shooting positions, the shooting directions, the staying times, and the moving speeds in a state where they are linked to each scene of video scenes. The information stored in the parameter storage unit 13 is searched for by the search processing unit 15 described later.

The UI unit 14 has an option setting unit 14a, an input processing unit 14b, and an output unit 14c. The option setting unit 14a receives setting of optional parameters for searching for a video scene through an operation performed by the searching user, and notifies the search processing unit 15 of the setting as optional conditions. Note that the UI unit 14 may be configured to receive specification of one label from among a plurality of labels indicating a cameraperson's action models as setting of optional parameters.

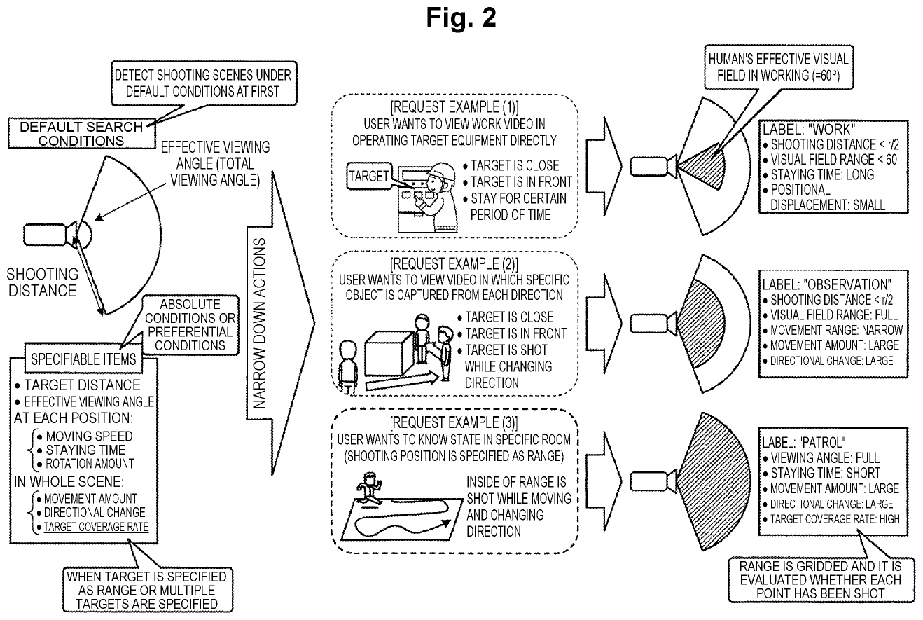

Here, setting of search options will be described using FIG. 2. FIG. 2 is a diagram illustrating setting of search options. A default search condition illustrated in FIG. 2 is, for example, a condition for, when a target position (or range) is input, determining whether the target position was shot in each scene, such as “whether the distance from the shooting position to the target is within a certain range”, or “whether the target is within the visual field range of the camera”. This default condition makes it possible to search for a video scene in which a particular object is shot. Further, specifiable items illustrated in FIG. 2 are parameters for further narrowing down video scenes in which the specific object is shot to scenes during a specific action. The specifiable items include, for example, the target distance (shooting distance) indicating the distance between the video acquisition apparatus 20 and the target object when the cameraperson shot it, the effective viewing angle of the video acquisition apparatus 20 when the cameraperson performed shooting, the moving speed, staying time and rotation amount of the video acquisition apparatus 20 at each position when the cameraperson performed shooting, the movement amount of the video acquisition apparatus 20 in the entire scene when the cameraperson performed shooting, the directional change of the video acquisition apparatus 20 in the entire scene, and the target coverage rate which is the proportion of a scene in which the target range is shot with respect to the entire scene.

Further, it is also possible to perform specification from labels of preset action models without inputting the parameters for specifiable items. For example, as illustrated in FIG. 2, the searching user specifies the label “work” if they want to see work video when the target equipment is directly operated. Thereby, the display apparatus 10 can easily further narrow down video scenes in which a specific object is shot to scenes during a specific action using the parameters for the shooting distance, the visual field range, the staying time, and the positional variation corresponding to the label “work”.

The input processing unit 14b receives specification of a position or range on the map through an operation performed by the searching user. For example, when the searching user wants to search for a video scene in which a specific object is shot, the input processing unit 14b receives a click operation on a point on the map where the object is located.

The output unit 14c displays a video scene found by the search processing unit 15 described later. For example, when receiving the time period of a corresponding scene as a search result from the search processing unit 15, the output unit 14c reads the video scene corresponding to the time period of the corresponding scene from the video storage unit 16, and outputs the read video scene. The video storage unit 16 saves video information shot by the video acquisition apparatus 20.

When receiving specification of a position or range on the map through a user's operation, the search processing unit 15 searches for information on a scene in the video information in which the specified position or range is shot using the information on the shooting target in each scene stored in the parameter storage unit 13, and outputs found information on the scene. For example, when receiving specification of a specific object position on the map through a user's operation via the input processing unit 14b, the search processing unit 15 makes an inquiry to the parameter storage unit 13 about shooting frames in which the specified shooting position is captured to acquire parameter lists of the shooting frames, and outputs the time period of a corresponding scene to the output unit 14c.

Further, when receiving specification of any one or more optional conditions of a shooting distance to an object, a visual field range, a movement range, a movement amount, and a directional change together with the specification of the position or range on the map, the search processing unit 15 extracts information on a scene in the video information that meets the optional conditions from information on scenes in the video information in which the specified position or range is shot, and outputs the extracted information on the scene. For example, the search processing unit 15 extracts only scenes that meet the optional conditions from scenes with the acquired parameter lists, and outputs the time period of the corresponding scene to the output unit 14c.

Further, the search processing unit 15 may be configured to receive specification of a label associated with any one or more conditions of the shooting distance, the visual field range, the movement range, the movement amount, and the directional change together with the specification of the position or range on the map, extract information on a scene in the video information that meets the conditions corresponding to the label from the information on the scenes in the video information in which the specified position or range is shot, and output the extracted information on the scene. That is, for example, when receiving specification of a label of a specific action model that the user wants to search for from a plurality of labels, the search processing unit 15 extracts only scenes that meet the optional conditions corresponding to the specified label, and outputs the time period of the corresponding scene to the output unit 14c.

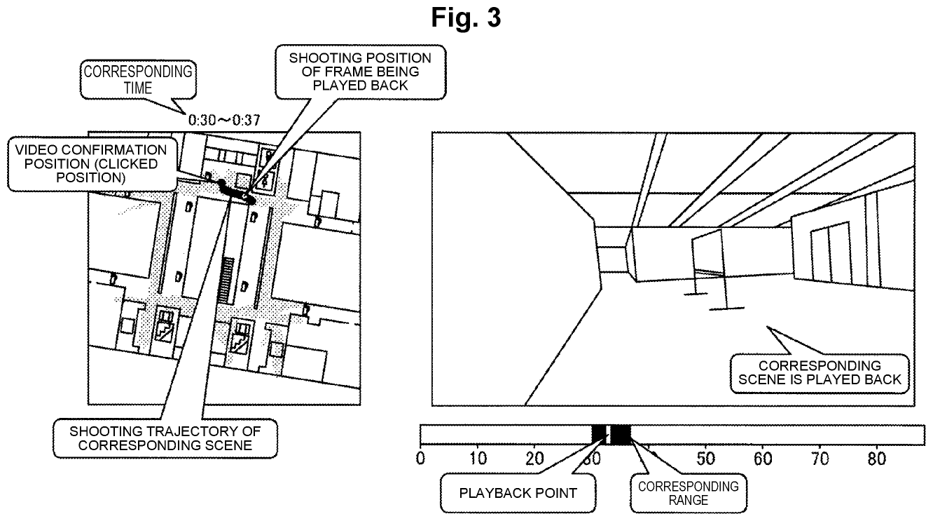

Here, an example of display of a found video scene will be described using FIG. 3. FIG. 3 is a diagram showing an example of display of a found video scene. As illustrated in FIG. 3, the display apparatus 10 displays a map on the left side of the screen, and when a position in the video desired to be confirmed is clicked through an operation performed by the searching user, it searches for a corresponding scene, and displays a moving picture of the corresponding scene on the right side of the screen.

In addition, the display apparatus 10 displays the time period of each found scene in the moving picture on the lower right, and plots and displays the shooting position of the corresponding scene on the map. Further, as illustrated in FIG. 3, the display apparatus 10 automatically plays back search results in order from the one at the earliest shooting time, and also displays the shooting position and shooting time of the scene being displayed.

### Processing Procedure in Display Apparatus

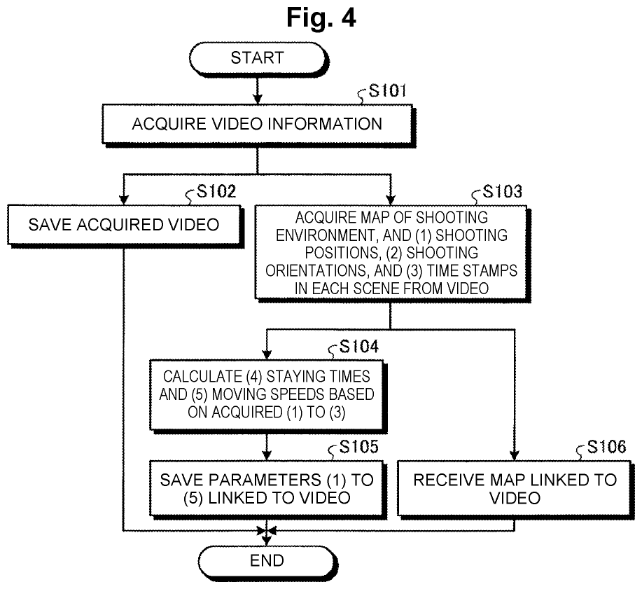

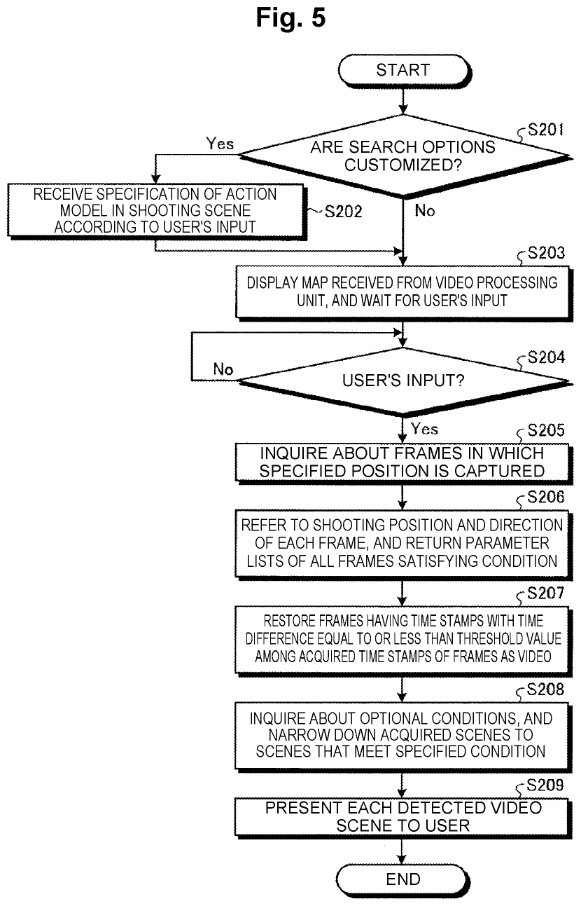

Next, an example of a processing procedure performed by the display apparatus 10 according to the first embodiment will be described using FIGS. 4 and 5. FIG. 4 is a flowchart showing an example of a processing flow at the time of storing video and parameters in the display apparatus according to the first embodiment. FIG. 5 is a flowchart showing an example of a processing flow at the time of searching in the display apparatus according to the first embodiment.

First, a processing flow at the time of storing video and parameters will be described using FIG. 4. As illustrated in FIG. 4, when acquiring video information (step S101), the video processing unit 11 of the display apparatus 10 saves the acquired video in the video storage unit 16 (step S102). Further, the video processing unit 11 acquires a map of a shooting environment, and the shooting positions, the shooting orientations, and the time stamps in each scene from the video (step S103). Note that the video processing unit 11 may acquire a map of the shooting environment, and the shooting positions, the shooting orientations, and the time stamps in each scene using techniques other than SLAM. For example, the video processing unit 11 may acquire the shooting positions with GPS or indoor-installed sensors in synchronization with the video, and map the acquired position information to an existing map.

Then, the parameter processing unit 12 calculates staying times and moving speeds based on the acquired shooting positions, shooting orientations, and time stamps in each scene (step S104), and saves the shooting positions, the shooting orientations, the time stamps, the staying times, and the moving speeds in each scene in the parameter storage unit 13 (step S105). Further, the input processing unit 14b receives the map linked to the video (step S106).

Next, a processing flow at the time of searching will be described using FIG. 5. As illustrated in FIG. 5, when the user customizes the search options (Yes in step S201), the option setting unit 14a of the display apparatus 10 receives specification of an action model at the time of shooting a scene as optional conditions according to the user's input (step S202).

Subsequently, the input processing unit 14b displays the map received from the video processing unit 11, and waits for the user's input (step S203). Then, when the input processing unit 14b receives the user's input (Yes in step S204), the search processing unit 15 inquires of the parameter storage unit 13 about frames in which the specified position is captured (step S205).

The parameter storage unit 13 refers to the shooting position and direction of each frame, and returns the parameter lists of all frames satisfying the condition, that is, frames in which the specified position is captured to the search processing unit 15 (step S206). Then, the search processing unit 15 restores frames having time stamps with an interval equal to or less than a predetermined threshold value among the acquired time stamps of the frames as video (step S207), inquires about the optional conditions, and narrows down the acquired scenes to scenes that meet the specified condition (step S208). Thereafter, the output unit 14c presents each detected video scene to the user (step S209).

### Effects of First Embodiment

In this way, the display apparatus 10 of the display system 100 according to the first embodiment generates a map of a shot region based on video information, and stores information on a shooting target on the map in the parameter storage unit 13 in association with each scene in the video information. Then, when receiving specification of a position or range on the map through a user's operation, the display apparatus 10 searches for information on a scene in the video information in which the specified position or range is shot using the information on the shooting target in each scene stored in the parameter storage unit 13, and outputs found information on the scene. Therefore, the display apparatus 10 produces an effect that a specific scene can be efficiently extracted from video even when there are many similar objects.

That is, in the display system 100, the user selects any target on the map or from a database linked to the map, thereby making it possible to discriminate and search for a video scene in which a specific target is shot even in a region where there are many similar objects.

In this way, in the display system 100, by building a function of narrowing down video scenes to those related to a specific confirmation target (object or space) when extracting a specific video scene from the video information, it is possible to provide support for the user to more effectively utilize video.

Further, in the display system 100, the SLAM technique is used as an elemental technique for mapping of the shooting position of each video scene onto the map to be used in specifying an object position, thereby making it possible to reduce or alleviate the burden on the user. That is, when the display apparatus 10 uses the SLAM map as it is as the map to be used at the time of specification, it is not necessary to prepare the map and map the shooting position, and even when a map different from the SLAM map is used, the position mapping can be completed only by the alignment with the SLAM map, so that the burden on the user can be reduced.

Further, in the display system 100, it is possible to efficiently search for a video scene that more matches the intended use of the video through a search using a cameraperson's action models even when there are many video scenes in which a specific object is shot.

### Second Embodiment

Although the above first embodiment has described a case where the display apparatus 10 searches for a video scene in which a specific object is shot based on the shooting position and the shooting direction, there is no limitation to this, for example, it is possible to acquire a list of frames in which each feature point is observed in generating a map, and search for a video scene in which a specific object is shot based on the list of frames.

In the following, as a second embodiment, a case will be described where a display apparatus 10A of a display system 100A generates a map from the video information by tracking feature points, and acquires a list of frames in which each feature point is observed in generating a map as the information on the shooting target, and when receiving specification of the position or range on the map, identifies a frame in which a feature point corresponding to the specified position or range is observed using the list of frames, searches for information on a scene in the video information in which the specified position or range is shot using information on the frame, and outputs found information on the scene. Note that the description of the same configuration and processing as in the first embodiment will be omitted as appropriate.

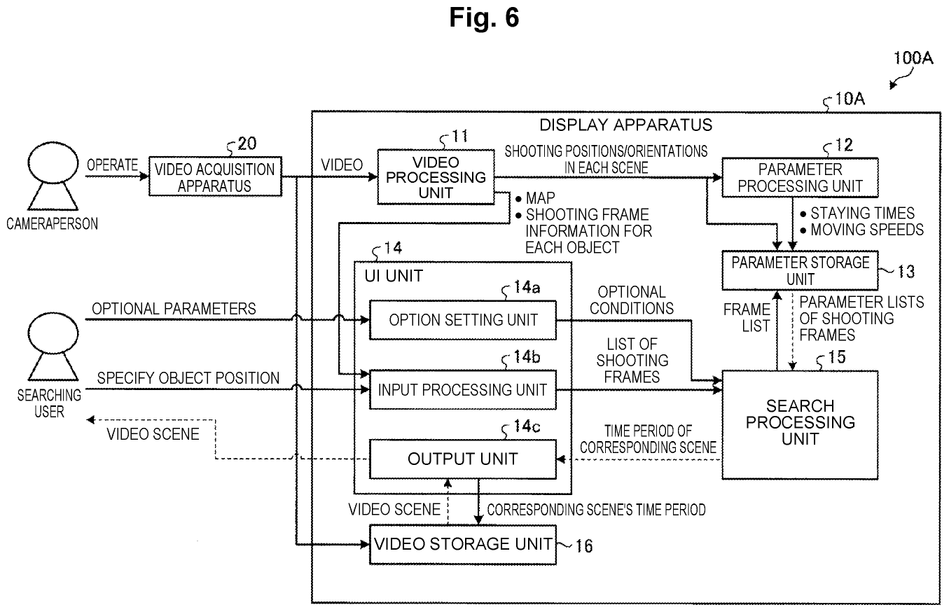

FIG. 6 is a diagram showing an example of a configuration of a display system according to the second embodiment. The video processing unit 11 of the display apparatus 10A generates a map from the video information by tracking feature points, and acquires a list of frames in which each feature point is observed in generating a map as the information on the shooting target. Specifically, the video processing unit 11 acquires frames in which each feature point is present when feature points detected from within frames by SLAM are tracked between continuous frames.

For example, the video processing unit 11 generates a map from the video information by tracking feature points using the technique of SLAM, acquires a list of frames in which each object is observed, and notifies the input processing unit 14b of it. Further, the video processing unit 11 acquires the shooting position and the shooting direction on the map as the information on the shooting target in association with each scene in the video information, notifies the parameter processing unit 12 of them, and stores them in the parameter storage unit 13.

When receiving specification of a position or range on the map through an operation performed by the searching user, the input processing unit 14b notifies the search processing unit 15 of the list of frames together with the specified position or range.

When receiving specification of the position or range on the map, the search processing unit 15 identifies a frame in which a feature point corresponding to the specified position or range is observed using the list of frames, searches for information on a scene in the video information in which the specified position or range is shot using information on the frame, and outputs found information on the scene.

For example, when receiving specification of a specific object position on the map through a user's operation via the input processing unit 14b, the search processing unit 15 makes an inquiry to the parameter storage unit 13 for corresponding frames based on a frame list corresponding to the object position to acquire parameters related to the corresponding frames, and outputs the time period of the corresponding scene to the output unit 14c.

### Processing Procedure in Display Apparatus

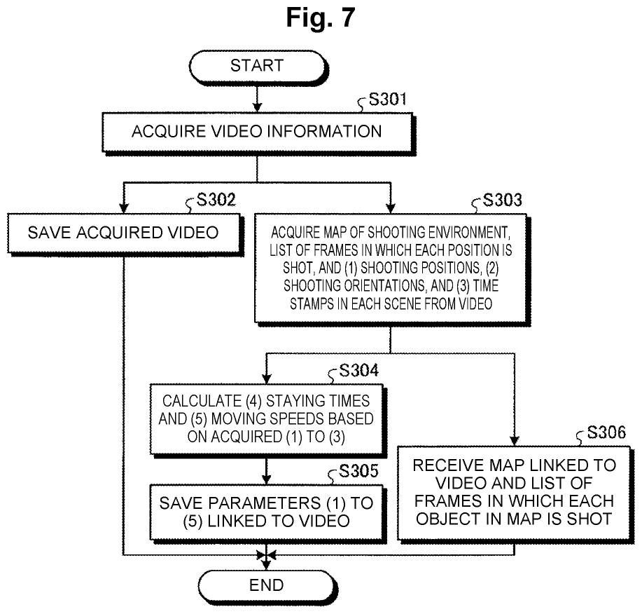

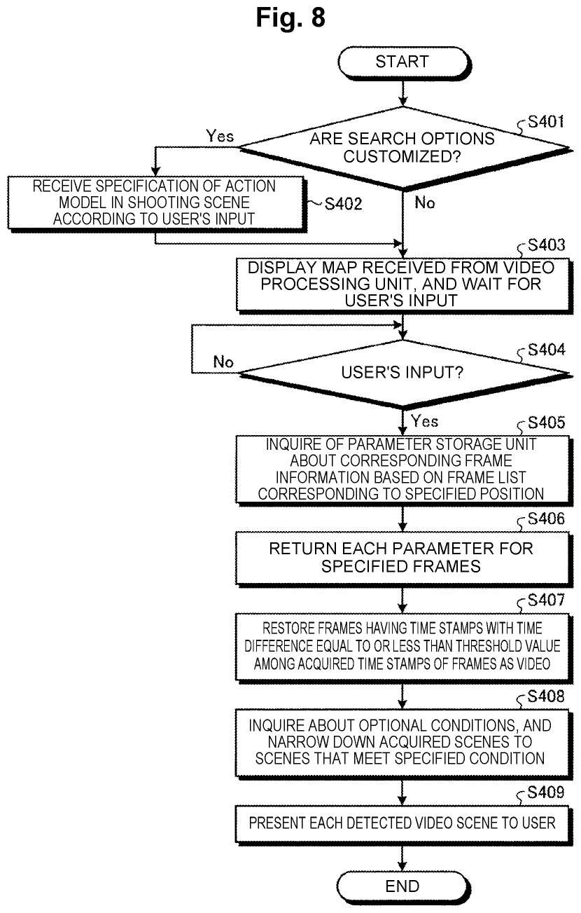

Next, an example of a processing procedure performed by the display apparatus 10A according to the second embodiment will be described using FIGS. 7 and 8. FIG. 7 is a flowchart showing an example of a processing flow at the time of storing video and parameters in the display apparatus according to the second embodiment. FIG. 8 is a flowchart showing an example of a processing flow at the time of searching in the display apparatus according to the first embodiment.

First, a processing flow at the time of storing video and parameters will be described using FIG. 7. As illustrated in FIG. 7, when acquiring video information (step S301), the video processing unit 11 of the display apparatus 10A saves the acquired video in the video storage unit 16 (step S302). Further, the video processing unit 11 acquires a map of the shooting environment, a list of frames in which each position is shot, and the shooting positions, shooting orientations, and time stamps in each scene from the video (step S303). For example, the video processing unit 11 acquires frames in which each feature point is present when feature points detected from within frames by SLAM are tracked between continuous frames.

Then, the parameter processing unit 12 calculates staying times and moving speeds based on the acquired shooting positions, shooting orientations, and time stamps in each scene (step S304), and saves the shooting positions, the shooting orientations, the time stamps, the staying times, and the moving speeds in each scene in the parameter storage unit 13 (step S305). Further, the input processing unit 14b receives a map linked to the video and a list of frames in which each object in the map is shot (step S306).

Next, a processing flow at the time of searching will be described using FIG. 8. As illustrated in FIG. 8, when the user customizes the search options (Yes in step S401), the option setting unit 14a of the display apparatus 10A receives specification of an action model at the time of shooting a scene as optional conditions according to the user's input (step S402).

Subsequently, the input processing unit 14b displays the map received from the video processing unit 11, and waits for the user's input (step S403). Then, when the input processing unit 14b receives the user's input (Yes in step S404), the search processing unit 15 inquires of the parameter storage unit 13 about corresponding frame information based on the frame list corresponding to the specified position (step S405).

The parameter storage unit 13 refers to the shooting position and direction of each frame, and returns the parameter lists of all frames satisfying the condition, that is, frames in which the specified position is captured to the search processing unit 15 (step S406). Then, the search processing unit 15 restores frames having time stamps with an interval equal to or less than a predetermined threshold value among the acquired time stamps of the frames as video (step S407). Then, the search processing unit 15 inquires about the optional conditions, and narrows down the acquired scenes to scenes that meet the specified condition (step S408). Thereafter, the output unit 14c presents each detected video scene to the user (step S409).

### Effects of Second Embodiment

In this way, in the display system 100A according to the second embodiment, the display apparatus 10A generates a map from the video information by tracking feature points, and acquires a list of frames in which each feature point is observed in generating a map as the information on the shooting target. Then, when receiving specification of a position or range on the map, the display apparatus 10A identifies a frame in which a feature point corresponding to the specified position or range is observed using the list of frames, searches for information on a scene in the video information in which the specified position or range is shot using information on the frame, and outputs found information on the scene. Therefore, the display apparatus 10A produces an effect that a specific scene can be efficiently extracted from video using information on a list indicating in which frame an observed feature point was present at the time of generating a map. For example, in the first embodiment, since a scene is detected only under the conditions of distance and angle, a scene may be detected even when there is a shielding object between the shooting position and the position of the target object and the target object is not captured actually. On the other hand, in the second embodiment, since “frames in which the corresponding feature point is captured actually” can be grasped, such a problem does not occur.

### Third Embodiment

The above first and second embodiments have described cases where the searching user specifies a position at the time of searching and searches for a video scene in which the specified position is shot. That is, for example, cases have been described in which, when the searching user wants to see a video scene in which a specific object is shot, the display apparatuses 10 and 10A receive specification of an object position on the map from the searching user, and search for a video scene in which the object position is shot. However, there is no limitation to such a case, for example, it is possible for the searching user to shoot video in real time and search for a video scene in which the same target object as in the shot video is shot.

In the following, as a third embodiment, a case will be described where a display apparatus 10B of a display system 100B acquires real-time video information shot by a user, generates a map of a shot region, identifies a shooting position and a shooting direction of the user on the map from the video information, and searches for information on a scene in which the shooting position and the shooting direction are the same or similar using the identified shooting position and shooting direction of the user. Note that the description of the same configuration and processing as in the first embodiment will be omitted as appropriate.

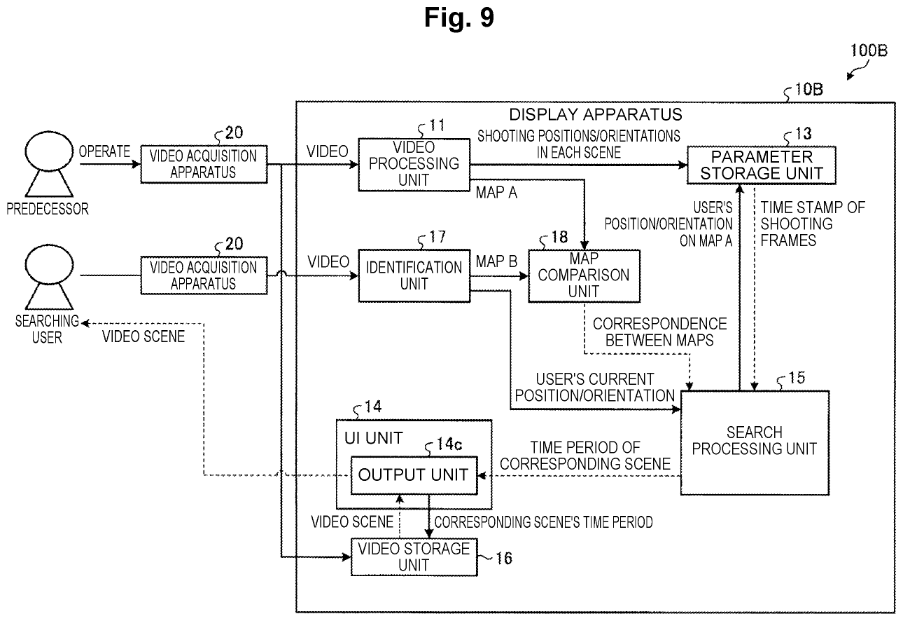

FIG. 9 is a diagram showing an example of a configuration of a display system according to the third embodiment. As illustrated in FIG. 9, the display apparatus 10B of the display system 100B is different from the first embodiment in that it has an identification unit 17 and a map comparison unit 18.

The identification unit 17 acquires real-time video information shot by the searching user from the video acquisition apparatus 20 such as a wearable camera, generates a map B of a shot region based on the video information, and identifies the shooting position and shooting direction of the user on the map from the video information. Then, the identification unit 17 notifies the map comparison unit 18 of the generated map B, and notifies the search processing unit 15 of the specified shooting position and shooting direction of the user. For example, the identification unit 17 may generate a map from the video information by tracking feature points using the technique of SLAM, and acquires the shooting positions and shooting directions in each scene, as in the video processing unit 11.

The map comparison unit 18 compares a map A received from the video processing unit 11 with the map B received from the identification unit 17, determines the correspondence between the two, and notifies the search processing unit 15 of the correspondence between the maps.

The search processing unit 15 searches for information on a scene in which the shooting position and the shooting direction are the same or similar from among the scenes stored in the parameter storage unit 13 using the shooting position and shooting direction of the user identified by the identification unit 17, and outputs found information on the scene. For example, the search processing unit 15 inquires about a video scene based on the shooting position and shooting direction of the searching user on the map A of a predecessor, acquires time stamps of shooting frames, and outputs the time period of a corresponding scene to the output unit 14c.

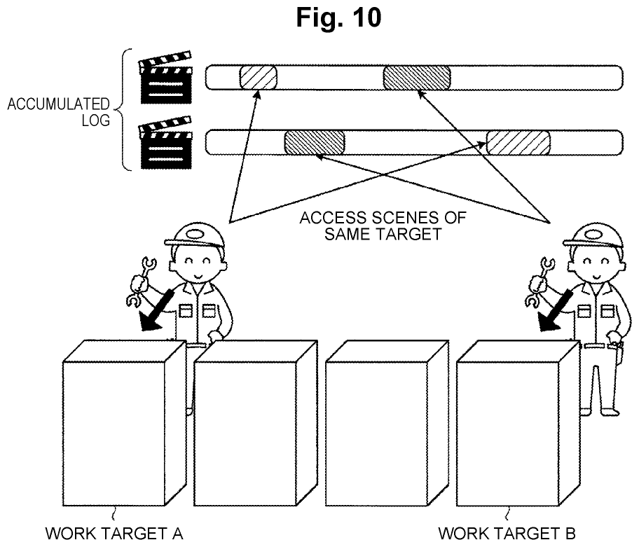

Thereby, the searching user can shoot viewpoint video up to a search point, and receive a video scene shot at the same viewpoint based on the comparison between the obtained map B and the stored map A. Here, an outline of a process of searching for a scene from the real-time viewpoint will be described using FIG. 10. FIG. 10 is a diagram illustrating an outline of a process of searching for a scene from the real-time viewpoint.

For example, when the user wants to view a past work history for a work target A in front of them, the user wearing a wearable camera moves in front of the work target A, shoots video of the work target A with the wearable camera, and instruct the display apparatus 10B to execute a search. The display apparatus 10B searches for a scene in the past work history for the work target A, and displays video of the scene. Note that, for example, the display apparatus 10B can map AR (augmented reality) onto the point cloud map of the predecessor in advance to extract AR corresponding to the user's position instead of video.

### Processing Procedure in Display Apparatus

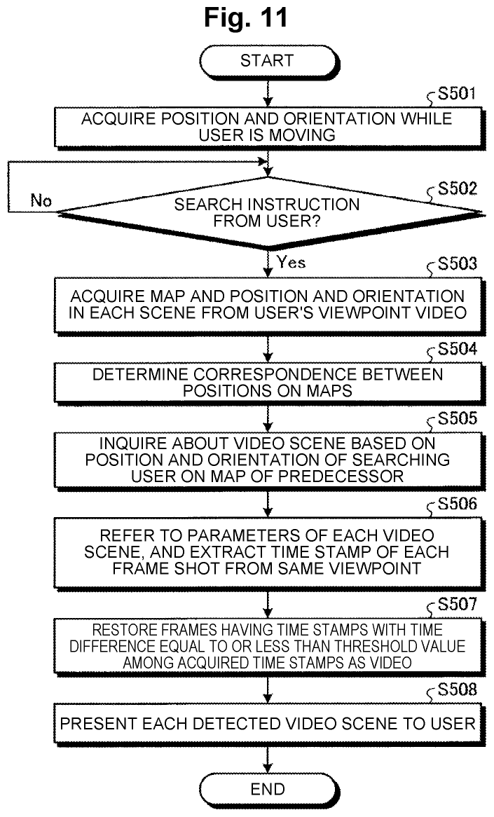

Next, an example of a processing procedure performed by the display apparatus 10B according to the third embodiment will be described using FIG. 11. FIG. 11 is a flowchart showing an example of a processing flow at the time of searching in the display apparatus according to the third embodiment.

As illustrated in FIG. 11, the video processing unit 11 of the display apparatus 10B acquires the position and orientation while the user is moving (step S501). Thereafter, the identification unit 17 determines whether a search instruction from the user has been received (step S502). Then, when receiving a search instruction from the user (Yes in step S502), the identification unit 17 acquires the map and the position and orientation in each scene from the user's viewpoint video (step S503).

Then, for the map of the predecessor and the map generated from the viewpoint video of the searching user, the map comparison unit 18 determines the correspondence between positions on the maps (step S504). Then, the search processing unit 15 inquires about a video scene based on the position and orientation of the searching user on the map of the predecessor (step S505).

Then, the parameter storage unit 13 refers to the parameters of each video scene, and extracts the time stamp of each frame shot from the same viewpoint (step S506). Then, the search processing unit 15 restores frames having time stamps with an interval equal to or less than a predetermined threshold value among the acquired time stamps of the frames as video (step S507). Thereafter, the output unit 14c presents each detected video scene to the user (step S508).

### Effects of Third Embodiment

In this way, in the display system 100B according to the third embodiment, the display apparatus 10B acquires real-time video information shot by a user, generates a map of a shot region based on the video information, and identifies a shooting position and a shooting direction of the user on the map from the video information. Then, the display apparatus 10B searches for information on a scene in which the shooting position and the shooting direction are the same or similar from among scenes stored in the parameter storage unit 13 using the identified shooting position and shooting direction of the user, and outputs found information on the scene. Therefore, the display apparatus 10B can realize a scene search from the real-time viewpoint, and for example, makes it possible to view a past work history for a work target in front in real time.

### System Configuration, Etc.

Further, each component of each apparatus shown in the figures is functionally conceptual, and does not necessarily have to be physically configured as shown in the figures. That is, the specific form of distribution/integration of each apparatus is not limited to those shown in the figures, and the whole or part thereof can be configured in a functionally or physically distributed/integrated manner in desired units according to various loads or usage conditions. Further, for each processing function performed in each apparatus, the whole or any part thereof may be implemented by a CPU and a program analyzed and executed by the CPU, or may be implemented as hardware by wired logic.

Further, among the processes described in the embodiments, all or part of the processes described as being performed automatically can be performed manually, or all or part of the processes described as being performed manually can be performed automatically using a known method. In addition, the processing procedures, control procedures, specific names, and information including various types of data and parameters described in the above document and shown in the drawings can be optionally modified unless otherwise specified.

### Program

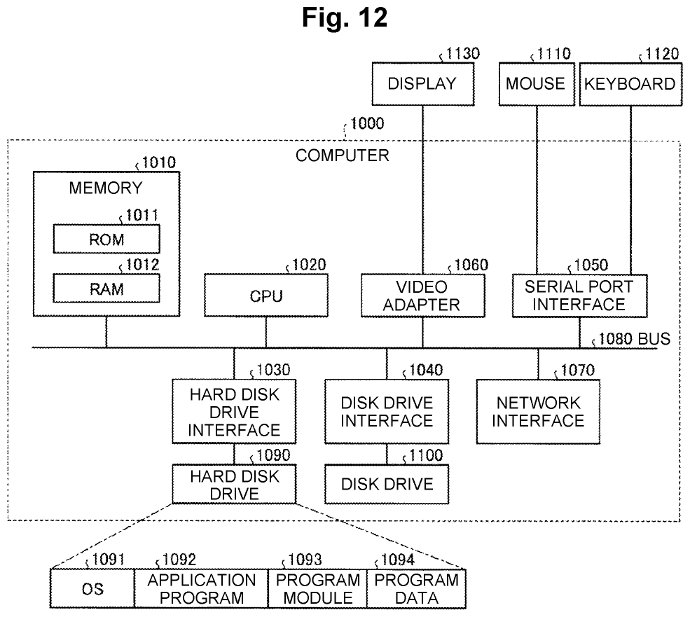

FIG. 12 is a diagram showing a computer that executes a display program. The computer 1000 has, for example, a memory 1010 and a CPU 1020. The computer 1000 also has a hard disk drive interface 1030, a disk drive interface 1040, a serial port interface 1050, a video adapter 1060, and a network interface 1070. These parts are connected to each other via a bus 1080.

The memory 1010 includes a ROM (read only memory) 1011 and a RAM 1012. The ROM 1011 stores, for example, a boot program such as a BIOS (basic input output system). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1051 and a keyboard 1052. The video adapter 1060 is connected to, for example, a display 1061.

The hard disk drive 1090 stores, for example, an OS 1091, an application program 1092, a program module 1093, and program data 1094. That is, a program that defines each process in the display apparatus is implemented as the program module 1093 in which a code executable by the computer is written. The program module 1093 is stored in, for example, the hard disk drive 1090. For example, the program module 1093 for executing the same processing as the functional configuration in the apparatus is stored in the hard disk drive 1090. Note that the hard disk drive 1090 may be replaced by an SSD (solid state drive).

Further, data used in the processing of the above-described embodiments is stored in, for example, the memory 1010 and the hard disk drive 1090 as the program data 1094. Then, the CPU 1020 reads and executes the program module 1093 and the program data 1094 stored in the memory 1010 and the hard disk drive 1090 onto the RAM 1012 as necessary.

Note that the program module 1093 and the program data 1094 are not limited to cases where they are stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network or WAN. Then, the program module 1093 and the program data 1094 may be read by the CPU 1020 from the other computer via the network interface 1070.

### REFERENCE SIGNS LIST

10, 10A, 10B Display apparatus

11 Video processing unit

12 Parameter processing unit

13 Parameter storage unit

14 UI unit

14a Option setting unit

14b Input processing unit

14c Output unit

15 Search processing unit

16 Video storage unit

17 Identification unit

18 Map comparison unit

20 Video acquisition apparatus

100, 100A, 100B Display system

1. A display system comprising:
a video processing unit, including one or more processors, configured to generate a map of a shot region based on video information, and acquire information on a shooting target on the map in association with each scene in the video information; and
a search processing unit, including one or more processors, that is configured to, when receiving specification of a position or range on the map through a user's operation, search for information on a scene in the video information in which the specified position or range is shot using the information on the shooting target in each scene, and output found information on the scene.

2. The display system according to claim 1, wherein, when receiving specification of any one or more conditions of a shooting distance to an object, a visual field range, a movement range, a movement amount, and a directional change together with the specification of the position or range on the map, the search processing unit is configured to extract information on a scene in the video information that meets the conditions from information on scenes in the video information in which the specified position or range is shot, and output the extracted information on the scene.

3. The display system according to claim 2, wherein the search processing unit is configured to receive specification of a label associated with any one or more conditions of the shooting distance, the visual field range, the movement range, the movement amount, and the directional change together with the specification of the position or range on the map, extract information on a scene in the video information that meets the conditions corresponding to the label from the information on the scenes in the video information in which the specified position or range is shot, and output the extracted information on the scene.

4. The display system according to claim 1, wherein
the video processing unit is configured to acquire a shooting position and a shooting direction on the map as the information on the shooting target in association with each scene in the video information, and store the shooting position and the shooting direction in a storage unit, and
when receiving specification of a position or range on the map, the search processing unit is configured to search for information on a scene in the video information in which the specified position or range is shot using the shooting position and the shooting direction in each scene stored in the storage unit, and output found information on the scene.

5. The display system according to claim 1, wherein
the video processing unit is configured to generate the map from the video information by tracking a feature point, and acquire a list of frames in which each feature point is observed in generating the map as the information on the shooting target, and
when receiving specification of a position or range on the map, the search processing unit is configured to identify a frame in which a feature point corresponding to the specified position or range is observed using the list of frames, search for information on a scene in the video information in which the specified position or range is shot using information on the frame, and output found information on the scene.

6. The display system according to claim 4, further comprising:
an identification unit, including one or more processors, configured to acquire real-time video information shot by a user, generate a map of a shot region based on the video information, and identify a shooting position and a shooting direction of the user on the map from the video information,
wherein the search processing unit is configured to search for information on a scene in which the shooting position and the shooting direction are the same or similar from among scenes stored in the storage unit using the shooting position and the shooting direction of the user identified by the identification unit, and output found information on the scene.

7. A display method executed by a display system, the display method comprising:
generating a map of a shot region based on video information, and acquiring information on a shooting target on the map in association with each scene in the video information; and
when receiving specification of a position or range on the map through a user's operation, searching for information on a scene in the video information in which the specified position or range is shot using the information on the shooting target in each scene, and outputting found information on the scene.

8. The display method according to claim 7, comprising:
when receiving specification of any one or more conditions of a shooting distance to an object, a visual field range, a movement range, a movement amount, and a directional change together with the specification of the position or range on the map, extracting information on a scene in the video information that meets the conditions from information on scenes in the video information in which the specified position or range is shot, and outputting the extracted information on the scene.

9. The display method according to claim 8, comprising:
receiving specification of a label associated with any one or more conditions of the shooting distance, the visual field range, the movement range, the movement amount, and the directional change together with the specification of the position or range on the map;
extracting information on a scene in the video information that meets the conditions corresponding to the label from the information on the scenes in the video information in which the specified position or range is shot; and
outputting the extracted information on the scene.

10. The display method according to claim 7, comprising:
acquiring a shooting position and a shooting direction on the map as the information on the shooting target in association with each scene in the video information;
storing the shooting position and the shooting direction in a storage unit; and
when receiving specification of a position or range on the map, searching for information on a scene in the video information in which the specified position or range is shot using the shooting position and the shooting direction in each scene stored in the storage unit, and outputting found information on the scene.

11. The display method according to claim 10, further comprising:
acquiring real-time video information shot by a user, generate a map of a shot region based on the video information;
identifying a shooting position and a shooting direction of the user on the map from the video information;
searching for information on a scene in which the shooting position and the shooting direction are the same or similar from among scenes stored in the storage unit using the shooting position and the shooting direction of the user; and
outputting found information on the scene.

12. The display method according to claim 7, comprising:
generating the map from the video information by tracking a feature point;
acquiring a list of frames in which each feature point is observed in generating the map as the information on the shooting target; and
when receiving specification of a position or range on the map, identifying a frame in which a feature point corresponding to the specified position or range is observed using the list of frames, searching for information on a scene in the video information in which the specified position or range is shot using information on the frame, and outputting found information on the scene.

13. A non-transitory computer readable medium storing one or more instructions causing a computer to execute:
generating a map of a shot region based on video information, and acquiring information on a shooting target on the map in association with each scene in the video information; and
when receiving specification of a position or range on the map through a user's operation, searching for information on a scene in the video information in which the specified position or range is shot using the information on the shooting target in each scene, and outputting found information on the scene.

14. The non-transitory computer readable medium according to claim 13, wherein the one or more instructions cause the computer to execute:
when receiving specification of any one or more conditions of a shooting distance to an object, a visual field range, a movement range, a movement amount, and a directional change together with the specification of the position or range on the map, extracting information on a scene in the video information that meets the conditions from information on scenes in the video information in which the specified position or range is shot, and outputting the extracted information on the scene.

15. The non-transitory computer readable medium according to claim 14, wherein the one or more instructions cause the computer to execute:
receiving specification of a label associated with any one or more conditions of the shooting distance, the visual field range, the movement range, the movement amount, and the directional change together with the specification of the position or range on the map;
extracting information on a scene in the video information that meets the conditions corresponding to the label from the information on the scenes in the video information in which the specified position or range is shot; and
outputting the extracted information on the scene.

16. The non-transitory computer readable medium according to claim 13, wherein the one or more instructions cause the computer to execute:
acquiring a shooting position and a shooting direction on the map as the information on the shooting target in association with each scene in the video information;
storing the shooting position and the shooting direction in a storage unit; and
when receiving specification of a position or range on the map, searching for information on a scene in the video information in which the specified position or range is shot using the shooting position and the shooting direction in each scene stored in the storage unit, and outputting found information on the scene.

17. The non-transitory computer readable medium according to claim 16, wherein the one or more instructions further cause the computer to execute:
acquiring real-time video information shot by a user, generate a map of a shot region based on the video information;
identifying a shooting position and a shooting direction of the user on the map from the video information;
searching for information on a scene in which the shooting position and the shooting direction are the same or similar from among scenes stored in the storage unit using the shooting position and the shooting direction of the user; and
outputting found information on the scene.

18. The non-transitory computer readable medium according to claim 13, wherein the one or more instructions cause the computer to execute:
generating the map from the video information by tracking a feature point;
acquiring a list of frames in which each feature point is observed in generating the map as the information on the shooting target; and
when receiving specification of a position or range on the map, identifying a frame in which a feature point corresponding to the specified position or range is observed using the list of frames, searching for information on a scene in the video information in which the specified position or range is shot using information on the frame, and outputting found information on the scene.
